(19) United States
(12) Patent Application Publication
(10) Pub. No.: US 2002/0116636 A1
(43) Pub. Date: Aug. 22, 2002

(54) Device and method for securing a container against unauthorized opening

(76) Inventors: Karl-Heinz Henne, Gammertingen (DE); Thomas Baisch, Albstach (DE)

Correspondence Address: BAKER & HOSTETLER LLP, Washington Square, Suite 1100, 1050 Connecticut Avenue, N.W., Washington, DC, 20036, US

(21) Appl. No.: 10/076,304

(22) Filed: Feb. 19, 2002

(30) Foreign Application Priority Data
Feb. 16, 2001 (DE) 10107444.1

(51) Int. Cl. H04L 9/32

(52) U.S. Cl. 713/200

(57) ABSTRACT

A device for securing a container, a drawer equipped with a remote-controlled locking device, for instance, against unauthorized opening is described. A workplace computer is equipped with a program for carrying out a security query, with which the access to the workplace computer is controlled. As a function of the running and the outcome of the security query, the locking device is simultaneously driven to lock or release the container. With the invention, it is assured that doors and drawers and the like are locked at all times when the authorized person is absent and, simultaneously, access by an unauthorized person to computer data is prevented.

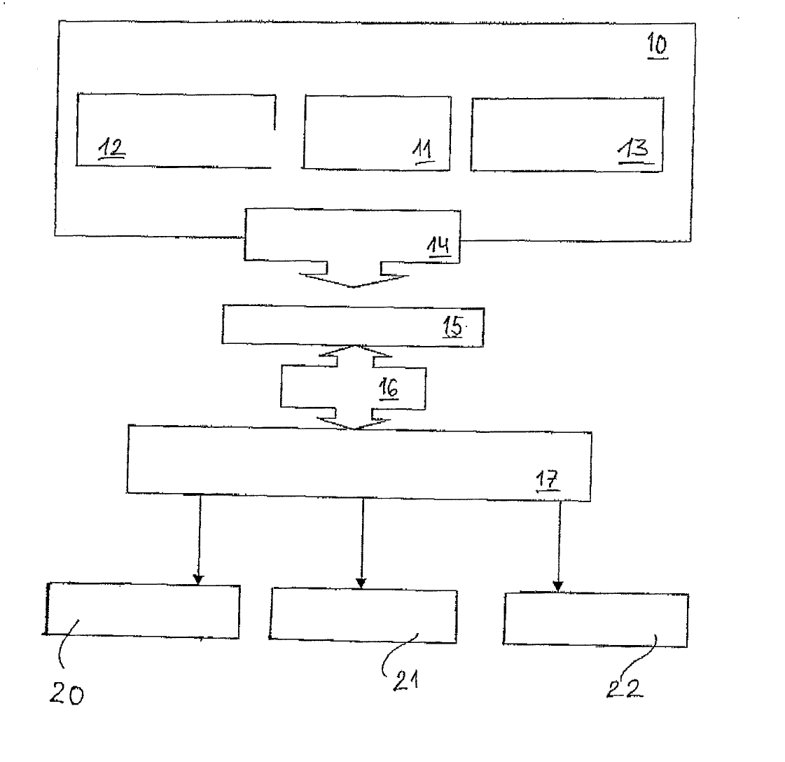

### FIELD OF THE INVENTION

The invention pertains to a device for securing at least one container, a drawer for instance, against unauthorized opening.

### BACKGROUND OF THE INVENTION

It has proven necessary and expedient to equip workplaces with lockable containers, such as drawers and cabinets. This is normally accomplished with a mechanical, key-operated lock. Experience has shown, however, that the lock is often not operated, particularly when one leaves the workplace for a brief time, and the contents of the container are then accessible to unauthorized persons. The security of the container contents is dependent exclusively on the care and attentiveness of the workplace user.

Locking such containers by remote control from a central station is also known. Locking in this case is done outside normal working hours, typically at night and on non-working days. Security is achieved in this manner independently of the individual case, but it is impossible in practical terms to use these protections during working hours.

### SUMMARY OF THE INVENTION

The invention is based on the problem of specifying a method and device of the initially mentioned type with which a container is better protected against unauthorized opening.

This problem is solved in terms of the device in that a data link is present to a workplace computer, in that the workplace computer is equipped with a program for performing a security query, with which access to the workplace computer is controlled, and in that an analysis unit driven by this program and a control unit for the locking device are present, which drive the locking device to lock or release the container as a function of the running and the outcome of the security query.

In terms of method, the problem is solved in that the locking device is unlocked or unlocked as a function of the result of the result of an authentication process simultaneously with the release or blocking of the workplace computer.

A basic concept of the invention is to be seen in the idea of employing the authentication process that is present in every workplace computer simultaneously for protecting access to a container at the workplace. This has the advantage that the user need not take any additional measures for securing the container, so that this is carried out practically automatically on the side and that an extremely high degree of security is nonetheless achieved. Another advantage is that the individual configuring of a workplace as well as a group of workplaces can be done simply in the context of a network with the programs present in the individual operating programs of the workplace computer and the network.

In particular, it is assured with the invention in conjunction with a password-protected screen saver that doors and drawers are locked during all times of absence of the user. Access to computer data by an unauthorized person is prevented by the screen saver. At the same time, written documents and the like are kept locked up so that optimal data security is provided with the highest degree of comfort. This applies both to hardware and software data.

It can be expedient that a device for biometric identification of a user is present and that the program for controlling a security query interacts with this identification device.

A particularly advantageous elaboration of the invention is that the user is automatically reminded when shutting down the computer that doors and drawers must be locked.

### BRIEF DESCRIPTION OF THE DRAWINGS

The Figure is a schematic block circuit diagram of a locking device of the present invention.

### DETAILED DESCRIPTION OF THE INVENTION

The invention is further described below on the basis of an embodiment illustrated in the drawing.

In the figure, 10 designates a workplace computer, which typically runs on the Windows NT operating system. Workplace computer 10 comprises a conventional authentication means such as a password-protected screensaver, which is represented as authentication module 11. As is known, an authentication serves to check the access authorization of a user. Authentication module 11 blocks access to video screen workplace 10 if the user does not successfully complete an authentication query and if the keyboard is not operated within a preset time in the course of work. Access is not released again until the user again completes an authorization check, such as the input of a defined password. In a workplace computer with a Windows NT operating system, such an authentication is controlled by a program component GINA.DLL (Graphical Identification and Authentication).

Various containers (not shown) in the workplace such as drawers and cabinets are each equipped with an ordinary commercial locking device 20, 21, 22 with an acknowledgment contact and which can be operated by an electric motor or electromagnetically. In this manner, the containers can be locked and unlocked by remote control.

An analysis unit 12 and control unit 13 in workplace computer 10 serve independently of one another to drive locking devices 20, 21, 22. Locking devices 20, 21, 22 are driven directly with control unit 13, in conjunction with the usual input means of a workplace computer, such as a keyboard or a mouse by the user's inputting of the appropriate commands.

Locking devices 20, 21, 22 are driven with analysis unit 12 in conjunction with authentication module 11. As a function of the status of the authentication, locking devices 20, 21, 22 are locked or unlocked. If the access protection, for instance, the screensaver, is activated, that is to say, if access to workplace computer 10 is blocked, locking devices 20, 21, 22 are simultaneously locked. If access protection is disabled by input of a correct password, then locking devices 20, 21, 22 are simultaneously unlocked.

The status of locking devices 20, 21, 22 is queried by way of the acknowledgement contact of locking devices 20, 21, 22. In this manner, it is possible for a record of the states of locking devices 20, 21, 22 to be kept in workplace computer 10.

The connection between workplace computer 10 and locking devices 20, 21, 22 is made by way of an ordinary interface 14 of workplace computer 10, preferably an RS-232 serial interface. A converter 15 which produces an adaptation to a bidirectional bus 16, is present at interface 14. Bus 16 is also connected to a control device 17, which drives the individual locking devices 20, 21, 22.

The process for securing the containers typically runs as follow. If one assumes that all containers are initially locked and workplace computer 10 is shut off, then a log-in to workplace computer 10 by an authorized user is first necessary. The user starts authentication module 11 and carries out an authentication. This is ordinarily done by inputting a password. In principle, however, other methods, such as a biometric authentication, are possible as well. When this process has been successfully completed, the user obtains access to the workplace computer locking elements 20, 21, 22 which are simultaneously driven to unlock the containers, so that the user also obtains access to the containers.

This combined access remains in effect as long as the user is active at workplace computer 10 by, for instance, operating the keyboard. If no activities are carried out at workplace computer 10 for a predetermined time, module 11 blocks access to work as [at] computer 10. Initiated by this blockage, locking devices 20, 21, 22 are simultaneously brought to the locked state, so that the containers are also no longer accessible. The blockage of computer 10 and the locking of the containers are jointly canceled only if another authentication process is successfully carried out.

When workplace computer 10 is being shut down and it is reported by the acknowledgment contacts of locking devices 20, 21, 22 that the containers are in the unlocked state, a prompt to lock the containers is displayed on the screen. The user can carry out the locking of locking devices 20, 21, 22 by remote control by means of control unit 13.

Alternatively, it can be provided that, while workplace computer 10 is being shut down, locking devices 20, 21, 22 are automatically locked by analysis unit 12.

What is claimed:

1. A device for securing at least one container, a drawer equipped with a remote-controlled locking device, for instance, against unauthorized opening, comprising:
a data link present to a workplace computer, in that said workplace computer is equipped with a program for performing a security query, with which access to said workplace computer is controlled, and in that an analysis unit driven by this program and a control unit for the locking device are present, which drive the locking device to lock or release the container as a function of the running and the outcome of the security query.

2. The device according to claim 1, wherein the program for controlling a security query is a screensaver with password prompt.

3. The device according to claim 1, wherein a device for biometric identification of a user is present and in that the program for controlling a security query interacts with this identification device.

4. The device according to claim 1, wherein several containers with locking devices which are driven by control unit are present.

5. The device according to claim 1, wherein each locking device is provided with a status reporter that sends status reports to analysis unit.

6. The device according to claim 5, wherein the analysis unit drives a video screen display on workplace computer as a function of the received status report.

7. The device according to claim 1, wherein the analysis unit and/or the control unit can be driven via an operating element of workplace computer to actuate locking device.

8. A method for securing a container, wherein the locking device is unlocked or locked simultaneously with the release or blockage of workplace computer as a function of the result of an authentication process.

9. The method according to claim 8, wherein when shutting down workplace computer, the user of the video screen workspace is automatically reminded that doors and drawers must be closed and locked.
